(19) United States
(12) Patent Application Publication
(10) Pub. No.: US 2026/0045744 A1
(43) Pub. Date: Feb. 12, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki SAKAI, Mie (JP); Shuya NISHIO, Mie (JP); Yuya TSUKAMOTO, Mie (JP)

(21) Appl. No.: 18/995,844

(22) PCT Filed: Jul. 10, 2023
(86) PCT No.: PCT/JP2023/025377

§ 371 Date: Jan. 17, 2025

(30) Foreign Application Priority Data
Jul. 28, 2022 (JP) 2022-120772

(51) Int. Cl. H01R 13/6592

(52) U.S. Cl. CPC H01R 13/6592

(57) ABSTRACT

A plurality of wires each including an electromagnetic shield member are electrically connected to a plurality of terminals arranged in a first direction. A plurality of shell rings respectively mounted on the plurality of wires are arranged in the first direction. An electrically conductive attachment is arranged between the shell rings adjacent in the first direction. Each shell ring electrically connects the electromagnetic shield member of the wire having the shell ring mounted thereon and a shield shell for covering the plurality of terminals. The attachment includes a covering portion for covering a gap between the shell rings adjacent in the first direction. Further, the attachment includes first and second pressing portions to be held in contact with contact surfaces adjacent to the attachment in the first direction and configured to press the contact surfaces with forces including components in a direction.

### TECHNICAL FIELD

The present disclosure relates to a connector.

### BACKGROUND

Conventionally, a connector is known which is provided with a plurality of terminals, a plurality of wires to be electrically connected to the plurality of terminals, a connector housing for holding the plurality of terminals and an electrically conductive shield shell, for example, as described in Patent Document 1. In the connector described in Patent Document 1, the wire is a shielded wire including a core wire to be electrically connected to the terminal, an insulation coating covering the outer periphery of the core wire and an electromagnetic shield member covering the outer periphery of the insulation coating. In such a connector, the plurality of terminals are, for example, arranged in a direction orthogonal to a length direction of the wires. Similarly, the plurality of wires are arranged in the direction orthogonal to the length direction of the wires inside the connector housing. Further, each of the plurality of wires is pulled out from the inside of the connector housing.

In the connector described in Patent Document 1, an end part of the electromagnetic shield member in the length direction of the wire is folded to cover the outer peripheral surface of the wire. An annular crimp ring is mounted on the outer periphery of the folded part of the electromagnetic shield member. The electromagnetic shield member and the crimp ring are electrically connected by contacting each other. The shield shell has a tubular shape surrounding the outer peripheries of the crimp rings respectively mounted on the plurality of wires. The shield shell and the respective crimp rings are electrically connected by contacting each other. Further, the crimp rings adjacent in the direction orthogonal to the length direction of the wires are in contact with each other in the direction orthogonal to the length direction of the wires.

### PRIOR ART DOCUMENT

### Patent Document

Patent Document 1: JP 2017-069159 A

### SUMMARY OF THE INVENTION

### Problems to be Solved

In recent years, a connector to be installed in a vehicle such as an automotive vehicle has been required to be compatible with a current having a large current value and a large voltage value in some cases. In these cases, a wire having a large diameter and capable of carrying a large current is used. Further, a terminal having a large cross-sectional area to be able to carry a large current is used as a terminal to be electrically connected to the wire. As the current value and the voltage value of the current carried in the terminal increase, a distance between the adjacent terminals needs to be increased to insulate the adjacent terminals. Thus, a distance between parts of the adjacent wires pulled out from a connector housing also becomes longer. Then, a gap is formed between crimp rings mounted on the adjacent wires in the connector. As a result, there is a concern that electromagnetic noise emitted from the wires and the terminals leaks to the outside of the connector from this gap and electromagnetic shielding performance is reduced.

The present disclosure aims to provide a connector capable of ensuring electromagnetic shielding performance while being compatible with larger currents.

### Means to Solve the Problem

The present disclosure is directed to a connector with a plurality of terminals arranged in a first direction, a plurality of wires to be electrically connected to the plurality of terminals, a connector housing for holding the plurality of terminals inside, the connector housing including a first opening, the plurality of wires being passed through the first opening in a second direction intersecting the first direction, an electrically conductive shield shell for covering the plurality of terminals, a plurality of shell rings respectively mounted on the plurality of wires, the shell rings being arranged in the first direction, and an electrically conductive shield attachment to be arranged between the shell rings adjacent in the first direction, the shield shell including a second opening, the plurality of wires being passed through the second opening in the second direction, each of the plurality of wires being a shielded wire including a core wire, an inner insulation coating covering an outer periphery of the core wire and an electrically conductive electromagnetic shield member covering an outer periphery of the inner insulation coating, each of the plurality of shell rings electrically connecting the electromagnetic shield member of the wire having the shell ring mounted thereon and the shield shell, an outer peripheral surface of each of the plurality of shell rings having a contact surface to be held in contact with the shield attachment, and the shield attachment including a covering portion located inside the second opening when viewed from the second direction, the covering portion covering a gap between the shell rings adjacent in the first direction, and a pressing portion to be held in contact with the contact surface adjacent to the shield attachment in the first direction, the pressing portion pressing the contact surface with a force including a component in a direction parallel to the first direction.

### Effect of the Invention

The connector of the present disclosure can ensure electromagnetic shielding performance while being compatible with larger currents.

### BRIEF DESCRIPTION OF THE DRAWINGS

FIG. 1 is a perspective view of a connector in one embodiment.

FIG. 2 is an exploded perspective view of the connector shown in FIG. 1.

FIG. 3 is a section along 3-3 in FIG. 4.

FIG. 4 is a section along 4-4 in FIG. 3.

FIG. 5 is a section enlargedly showing a part of the connector shown in FIG. 1.

FIG. 6 is a perspective view partly in section of a part of the connector shown in FIG. 1 except a connector housing when viewed at an angle different from that in FIG. 1.

FIG. 7 is a side view partly in section of the connector shown in FIG. 6 except the connector housing.

FIG. 8 is a section enlargedly showing a part of the connector shown in FIG. 6 except the connector housing.

FIG. 9 is a perspective view of a shield attachment provided in the connector shown in FIG. 1.

FIG. 10 is a perspective view of a back retainer holder and the shield attachments provided in the connector shown in FIG. 1.

FIG. 11 is a section of the back retainer holder and the shield attachments shown in FIG. 10.

### DETAILED DESCRIPTION TO EXECUTE THE INVENTION

### Description of Embodiments of Present Disclosure

First, embodiments of the present disclosure are listed and described.

[1] The connector of the present disclosure is provided with a plurality of terminals arranged in a first direction, a plurality of wires to be electrically connected to the plurality of terminals, a connector housing for holding the plurality of terminals inside, the connector housing including a first opening, the plurality of wires being passed through the first opening in a second direction intersecting the first direction, an electrically conductive shield shell for covering the plurality of terminals, a plurality of shell rings respectively mounted on the plurality of wires, the shell rings being arranged in the first direction, and an electrically conductive shield attachment to be arranged between the shell rings adjacent in the first direction, the shield shell including a second opening, the plurality of wires being passed through the second opening in the second direction, each of the plurality of wires being a shielded wire including a core wire, an inner insulation coating covering an outer periphery of the core wire and an electrically conductive electromagnetic shield member covering an outer periphery of the inner insulation coating, each of the plurality of shell rings electrically connecting the electromagnetic shield member of the wire having the shell ring mounted thereon and the shield shell, an outer peripheral surface of each of the plurality of shell rings having a contact surface to be held in contact with the shield attachment, and the shield attachment including a covering portion located inside the second opening when viewed from the second direction, the covering portion covering a gap between the shell rings adjacent in the first direction, and a pressing portion to be held in contact with the contact surface adjacent to the shield attachment in the first direction, the pressing portion pressing the contact surface with a force including a component in a direction parallel to the first direction.

According to this configuration, the shield attachment is electrically connected to the shell ring by the contact of the pressing portion with the contact surface. It can be suppressed by the covering portion that electromagnetic noise emitted from the wires and the terminals leaks to the outside of the connector through the gap between the shell rings adjacent in the first direction. Therefore, even if the shell rings adjacent in the first direction are arranged apart in the first direction, the electromagnetic shielding performance of the connector can be ensured.

Further, the pressing portion presses the contact surface with the force including the component in the direction parallel to the first direction. Thus, the shell ring hardly vibrates in the first direction. Therefore, the vibration in the first direction of the wire having the shell ring mounted thereon can be suppressed.

[2] In [1] described above, the pressing portions may press the contact surfaces of the shell rings located on both sides of the shield attachment in the first direction on both sides of a virtual straight line passing through centers of the plurality of wires when viewed from the second direction.

According to this configuration, the shield attachment can contact the shell ring at a plurality of positions. Thus, the electrical connection of the shield attachment and the shell ring is stabilized as compared to the case where the shield attachment and the shell ring adjacent to the shield attachment are in contact at one position. Further, the vibration of the shell ring is more easily suppressed as compared to the case where the shield attachment presses the shell ring adjacent thereto by the pressing portion only at one position.

[3] In [1] or [2] described above, the pressing portion may press a part intersecting a virtual straight line passing through centers of the plurality of wires on the contact surface of the shell ring adjacent to the shield attachment in the first direction when viewed from the second direction.

According to this configuration, a force for pressing the wire in the direction parallel to the first direction can be stably transmitted to the wire via the shell ring from the pressing portion. Therefore, the vibration of the wire in the first direction can be more suppressed.

[4] In any one of [1] to [3] described above, the shield attachment may include a contact portion to be held in contact with the shield shell.

According to this configuration, the shield attachment is not only electrically connected to the shield shell indirectly via the shell rings, but also electrically connected to the shield shell directly by the contact of the contact portion with the shield shell. Thus, the shield attachment can be more stably electrically connected to the shield shell. Therefore, the electromagnetic shielding performance can be ensured in the shield attachment.

[5] In any one of [1] to [4] described above, the pressing portion may include a leaf spring portion and a contact protrusion projecting from a surface of the leaf spring portion and to be pressed against the contact surface by a resilient force of the leaf spring portion.

According to this configuration, the contact protrusion easily contacts the contact surface since being shaped to project from the leaf spring portion. Since the contact protrusion is pressed against the contact surface by the resilient force of the leaf spring portion, the pressing portion is easily maintained in contact with the contact surface. Therefore, the electrical connection of the shell ring and the shield attachment can be stabilized.

[6] In any one of [1] to [5] described above, the contact surface may be a flat surface perpendicular to the first direction.

According to this configuration, a force in the direction parallel to the first direction can be easily applied from the pressing portion to the shell ring by the pressing portion pressing the contact surface. Thus, the vibration of the shell ring in the first direction can be more suppressed. Therefore, the vibration of the wire in the first direction can be even more suppressed.

[7] In any one of [1] to [6] described above, each of the plurality of shell rings may have a rectangular outer shape when viewed from the second direction, the outer peripheral surface of each of the plurality of shell rings may have two surfaces parallel to the first direction and two surfaces perpendicular to the first direction when viewed from the second direction, and the contact surface may be included in the surface perpendicular to the first direction, out of the outer peripheral surface of each of the plurality of shell rings.

According to this configuration, it can be suppressed that the shape of the gap between the shell rings adjacent in the first direction becomes complicated. Thus, it can be suppressed that the shape of the covering portion for covering the gap becomes complicated, wherefore it can be suppressed that the shape of the shield attachment becomes complicated. As a result, the manufacturing of the shield attachment is facilitated. Further, since the gap between the shell rings adjacent in the first direction can be easily covered by the covering portion, the electromagnetic shielding performance of the connector can be easily ensured.

[8] In any one of [1] to [7] described above, the connector may be further provided with a back retainer holder to be mounted into the first opening, the back retainer holder including a through hole, the plurality of wires being passed through the through hole in the second direction, and a sealing member for sealing between an outer peripheral surface of each of the plurality of wires and an inner peripheral surface of the through hole, and the shield attachment may be arranged between the shell rings adjacent in the first direction while being mounted on the back retainer holder.

According to this configuration, in assembling the connector, the back retainer holder having the shield attachment mounted thereon can be mounted into the first opening. By doing so, the shield attachment can be easily arranged between the shell rings adjacent in the first direction as compared to the case where the shield attachment is singly inserted between the shell rings adjacent in the first direction. Further, since the shield attachment is mounted on the back retainer holder, a position shift of the shield attachment inside the connector can be suppressed.

### Details of Embodiments of Present Disclosure

A specific example of a connector of the present disclosure is described below with reference to the drawings. For the convenience of description, some components may be shown in an exaggerated or simplified manner in each drawing. Further, a dimension ratio of each part may be different in each figure. In each figure, X, Y and Z axes orthogonal to each other are shown. “Orthogonal” in this specification means not only strictly orthogonal, but also substantially orthogonal within a range in which functions and effects in this embodiment are achieved. Further, a term “annular” used in this specification may indicate an arbitrary structure forming a loop, i.e. a continuous shape free from an end part or a loop-shaped structure as a whole including a gap such as a C shape. “Annular shapes” include circular shapes, elliptical shapes and polygonal shapes with angular or round corners, but there is no limitation to these. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

Hereinafter, one embodiment of a connector is described.

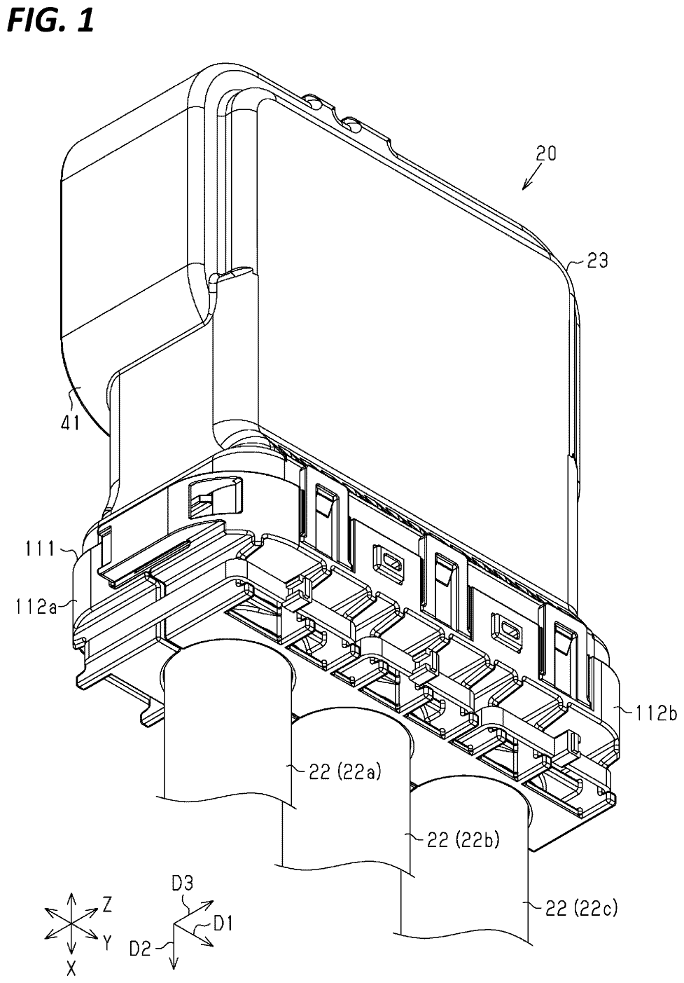

A connector 20 of this embodiment shown in FIG. 1 is provided on an end part of a wiring harness. The connector 20 is arranged in a vehicle such as an automotive vehicle. The vehicle includes, for example, a plurality of devices such as a high-voltage battery, an inverter and a wheel drive motor. The connector 20 is connected to one of the plurality of devices.

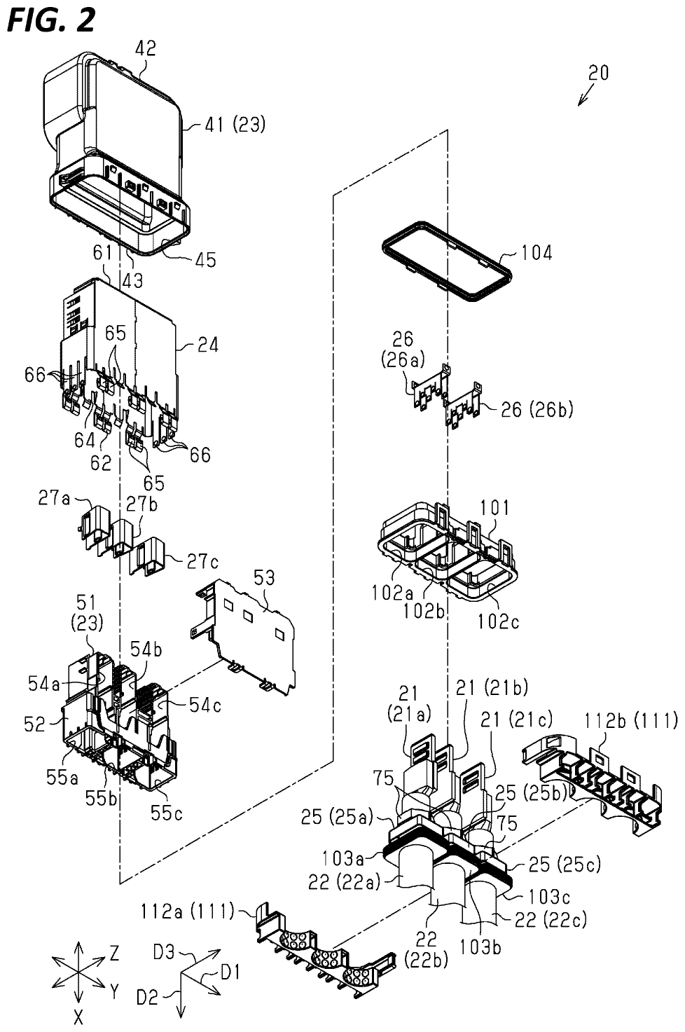

As shown in FIG. 2, the connector 20 is provided with a plurality of terminals 21, a plurality of wires 22, a connector housing 23, a shield shell 24, a plurality of shell rings 25 and shield attachments 26.

### (Configuration of Terminals 21)

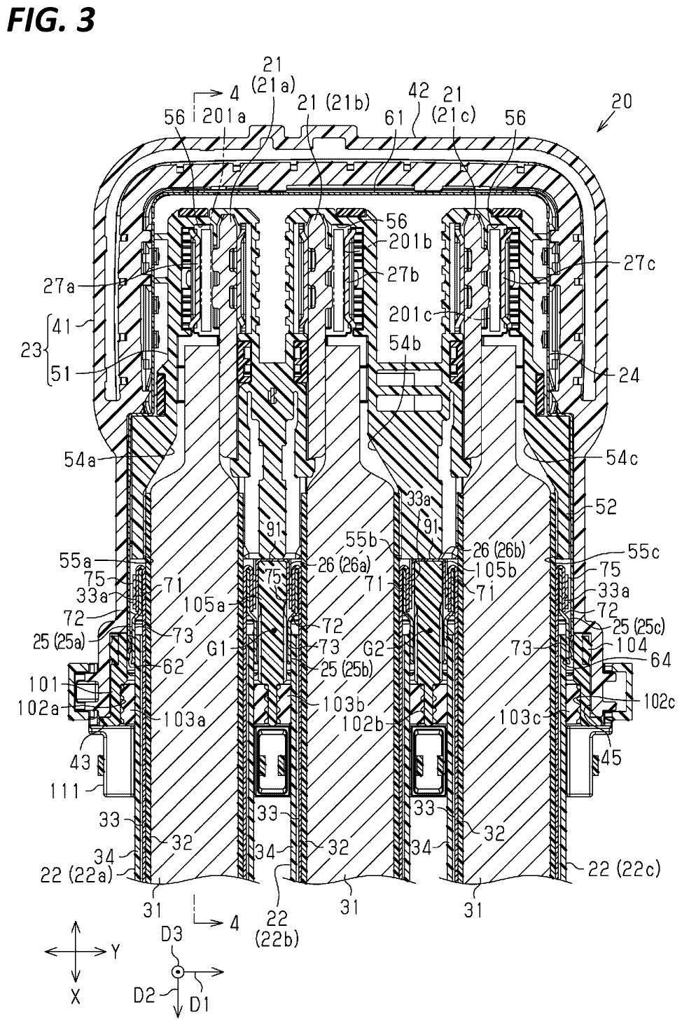

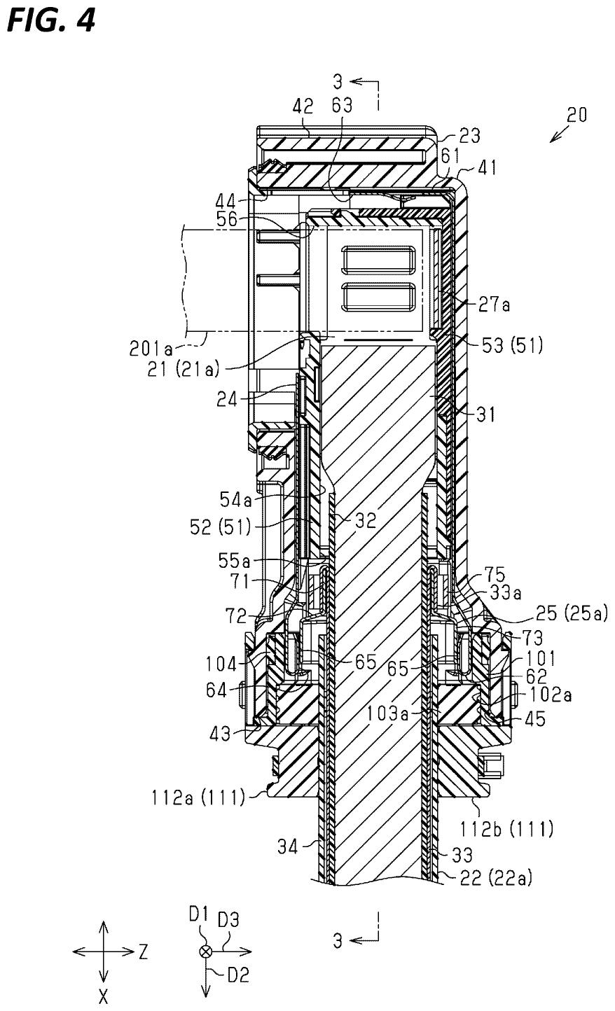

As shown in FIGS. 2 and 3, the connector 20 is, for example, provided with three terminals 21 including terminals 21a, 21b and 21c. Note that FIG. 3 is a section along 3-3 in FIG. 4. Each of the terminals 21a, 21b and 21c is made of a metal material such as copper, copper alloy, aluminum or aluminum alloy. The terminals 21a, 21b and 21c have, for example, the same shape. Each of the terminals 21a, 21b and 21c is, for example, plate-like. The terminals 21a, 21b and 21c are arranged in a first direction D1. The first direction D1 is an arbitrarily set direction. The first direction D1 is, for example, a direction along the Y axis. The terminals 21a, 21b and 21c are so arranged that a thickness direction thereof is along the first direction D1. Further, the terminals 21a, 21b and 21c are arranged at intervals. For example, the terminals 21a, 21b and 21c are arranged along the first direction D1 in the order of the terminals 21a, 21b and 21c.

Note that a direction intersecting the first direction D1 is a second direction D2. The second direction D2 is, for example, a direction perpendicular to the first direction D1. For example, the second direction D2 is a direction along the X axis. Further, a direction orthogonal to the first direction D1 and the second direction D2 is a third direction D3. The third direction D3 is, for example, a direction along the Z axis. The first, second and third directions D1, D2 and D3 are directions in a state where the connector 20 is assembled unless other particularly specified.

The terminals 21a, 21b and 21c are electrically connected to mating terminals 201a, 201b and 201c provided in a mating connector to be connected to the connector 20. The mating terminals 201a, 201b and 201c are shown by two-dot chain lines in FIG. 3. The connector 20 may be provided with a clip terminal 27a for sandwiching the mating terminal 201a and the terminal 21a inserted into the connector 20. The mating terminal 201a is, for example, inserted into the connector 20 along the third direction D3. The clip terminal 27a presses the mating terminal 201a against the terminal 21a by sandwiching the terminal 21a and mating terminal 201a. Similarly, the connector 20 may be provided with a clip terminal 27b for sandwiching the mating terminal 201b and the terminal 21b inserted into the connector 20 and a clip terminal 27c for sandwiching the mating terminal 201c and the terminal 21c inserted into the connector 20. Each of the clip terminals 27a, 27b and 27c is, for example, formed by press-working a metal plate of copper, copper alloy, aluminum, aluminum alloy, stainless steel or the like.

### (Configuration of Wires 22)

The connector 20 is provided with as many wires 22 as the terminals 21. The connector 20 is, for example, provided with three wires 22 including the wires 22a, 22b and 22c. Each of the wires 22a, 22b and 22c is a shielded wire having an electromagnetic shielding structure. The wires 22a, 22b and 22c have, for example, the same configuration. Each of the wires 22a, 22b and 22c is, for example, a high-voltage wire compatible with high voltage sand large currents.

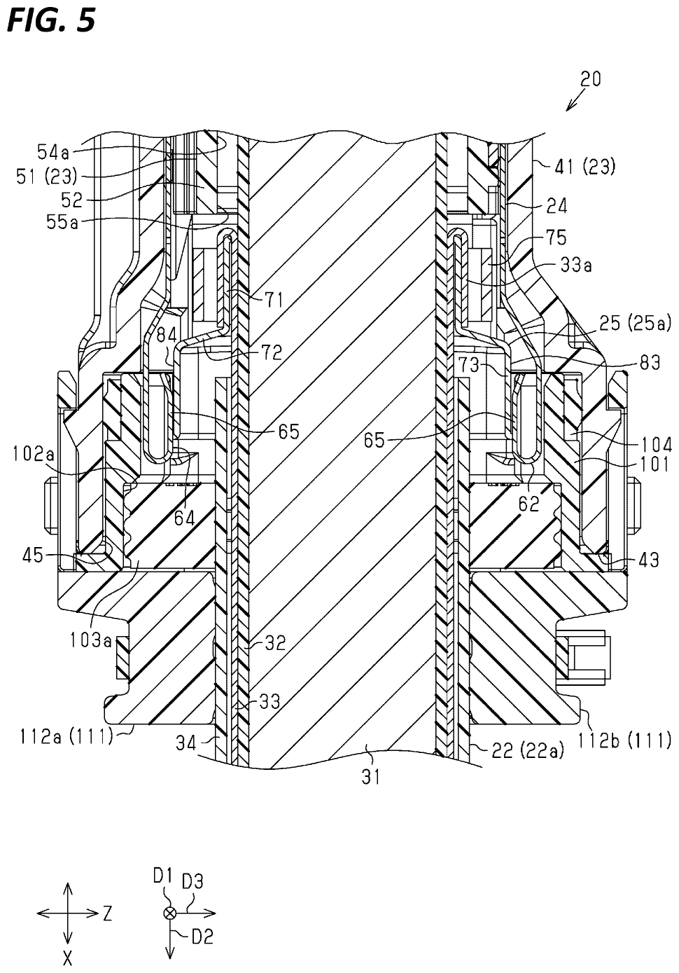

As shown in FIGS. 3, 4 and 5, each of the wires 22a, 22b and 22c includes a core wire 31 constituted by a conductor, an inner insulation coating 32 covering the outer periphery of the core wire 32 and an electromagnetic shield member 33 covering the outer periphery of the inner insulation coating 32. Further, each of the wires 22a, 22b and 22c may further include an outer insulation coating 34 covering the outer periphery of the electromagnetic shield member 33. Note that FIG. 4 is a section along 4-4 in FIG. 3. Further, FIG. 5 is a partial enlarged view of FIG. 4. Only the wire 22a is shown in FIGS. 4 and 5. For example, each of the wires 22a, 22b and 22c has a circular transverse cross-sectional shape. Note that a transverse cross-section of the wire 22 is a cross-section orthogonal to a length direction of the wire 22. The length direction of the wire 22 is equivalent to an X-axis direction in this embodiment. Incidentally, the transverse cross-sectional shape of each of the wires 22a, 22b and 22c is not limited to a circular shape, but may be any shape, out of an elliptical shape, a rectangular shape with round corners, a polygonal shape and other arbitrary shapes.

For example, a copper-based or aluminum-based metal material can be used as a material of the core wire 31. Each of the inner insulation coating 32 and the outer insulation coating 34 is, for example, made of an insulating material such as synthetic resin. The electromagnetic shield member 33 is, for example, a braided wire formed by braiding electrically conductive strands of copper alloy, aluminum alloy or the like into a tubular shape.

Each of the wires 22a, 22b and 22c extends in the second direction D2. That is, the connector 20 may be a connector, into which the mating terminals 201a, 201b and 201c are inserted in a direction intersecting an extension direction of the wires 22a, 22b and 22c. The wires 22a, 22b and 22c are respectively electrically connected to the terminals 21a, 21b and 21c. The core wire 31 is exposed in an end region of the wire 22a in a direction opposite to the second direction D2. An exposed part of the core wire 31 of the wire 22a is joined to the terminal 21a, for example, by crimping, welding such as ultrasonic welding or laser welding, or another known joining method. The wire 22b and the terminal 21b, and the wire 22c and the terminal 21c are also joined to each other, similarly to the wire 22a and the terminal 21a.

The wires 22a, 22b and 22c are arranged in the first direction D1, similarly to the terminals 21a, 21b and 21c, inside the connector 20. Further, the wires 22a, 22b and 22c are arranged at intervals in the first direction D1 inside the connector 20.

### (Configuration of Connector Housing 23)

As shown in FIGS. 2 and 3, the connector housing 23 holds the plurality of terminals 21a, 21b and 21c inside. The connector housing 23 includes, for example, an outer housing 41 constituting the outer shell of the connector 20 and an inner housing 51 to be arranged inside the outer housing 41. The outer housing 41 and the inner housing 51 are, for example, made of synthetic resin.

As shown in FIG. 4, the outer housing 41 has a tubular shape extending in the second direction D2. The outer housing 41 includes a first end 42 and a second end 43 opposite to the first end 42 in the second direction D2. The first end 42 of the outer housing 41 is closed.

The outer housing 41 includes a first connection opening 44, into which the mating terminals 201a, 201b and 201c are inserted along the third direction D3. The first connection opening 44 is located between the first end 42 and the second end 43 in the X-axis direction. Further, the outer housing 41 includes a first opening 45, through which the wires 22a, 22b and 22c are passed in the second direction D2. The first opening 45 is located at the second end 43 of the outer housing 41. Each of the first connection opening 44 and the first opening 45 allows communication between the inside and outside of the outer housing 41.

As shown in FIGS. 2, 3 and 4, the inner housing 51 is inserted into the outer housing 41 in a direction opposite to the second direction D2 through the first opening 45. The inner housing 51 includes, for example, an inner housing body 52 and a lid body 53.

The inner housing body 52 includes an accommodation recess 54a for accommodating the terminal 21a, an accommodation recess 54b for accommodating the terminal 21b and an accommodation recess 54c for accommodating the terminal 21c. Note that only the accommodation recess 54a is shown in FIG. 4. Each of the accommodation recesses 54a, 54b and 54c is, for example, recessed in a direction opposite to the third direction D3. Each of the accommodation recesses 54a, 54b and 54c is open in the third direction D3. The lid body 53 is detachably mounted on the inner housing body 52 in the direction opposite to the third direction D3 to close openings of the accommodation recesses 54a, 54b and 54c.

The inner housing body 52 includes a wire through opening 55a, through which the wire 22a is passed, a wire through opening 55b, through which the wire 22b is passed, and a wire through opening 55c, through which the wire 22c is passed, in an end part in the second direction D2. Each of the wire through openings 55a, 55b and 55c is open in the second direction D2.

The inner housing body 52 holds the terminals 21a, 21b and 21c in a state arranged in the first direction D1. Further, the inner housing 51 accommodates an electrically connected part of the terminal 21a and the wire 22a, an electrically connected part of the terminal 21b and the wire 22b and an electrically connected part of the terminal 21c and the wire 22c inside. Note that the electrically connected part of the terminal 21a and the wire 22a is a part where the terminal 21a and the wire 22a are joined. Similarly, the electrically connected part of the terminal 21b and the wire 22b is a part where the terminal 21b and the wire 22b are joined. The electrically connected part of the terminal 21c and the wire 22c is a part where the terminal 21c and the wire 22c are joined.

The wire 22a electrically connected to the terminal 21a is pulled to the outside of the connector housing 23 through the wire through opening 55a and the first opening 45. The wire 22b electrically connected to the terminal 21b is pulled to the outside of the connector housing 23 through the wire through opening 55b and the first opening 45. The wire 22c electrically connected to the terminal 21c is pulled to the outside of the connector housing 23 through the wire through opening 55c and the first opening 45.

The inner housing body 52 includes terminal insertion openings 56 in bottom parts of the respective accommodation recesses 54a, 54b and 54c. Each of the terminal insertion openings 56 is exposed to the outside of the connector 20 through the first connection opening 44. When the connector 20 and the mating connector are connected, the mating terminal 201a inserted into the connector 20 through the first connection opening 44 along the third direction D3 is inserted into the inner housing 51, i.e. into the accommodation recess 54a, through the terminal insertion opening 56. Then, the mating terminal 201a overlaps the terminal 21a and contacts the terminal 21a in the first direction D1 inside the accommodation recess 54a. By the contact of the terminal 21a and the mating terminal 201a, the terminal 21a and the mating terminal 201a are electrically connected. Similarly, the mating terminal 201b is electrically connected to the terminal 21b accommodated inside the accommodation recess 54b, and the mating terminal 201c is electrically connected to the terminal 21c accommodated inside the accommodation recess 54c.

### (Configuration of Shield Shell 24)

The shield shell 24 covers the terminals 21a, 21b and 21c. The shield shell 24 is electrically conductive. For example, the shield shell 24 is formed by press-working a metal plate.

For example, the shield shell 24 covers the outer surface of the inner housing 51. The shield shell 24 is arranged inside the outer housing 41 together with the inner housing 51. For example, the shield shell 24 is inserted into the outer housing 41 through the first opening 45 together with the inner housing 51.

The shield shell 24 has, for example, a tubular shape extending in the second direction D2. Further, the shield shell 24 has, for example, a rectangular shape long in a Y-axis direction when viewed from the second direction D2. The shield shell 24 includes a third end 61 and a fourth end 62 opposite to the third end 61 in the second direction D2. The third end 61 of the shield shell 24 is closed. The shield shell 24 includes a second connection opening 63, through which the mating terminals 201a, 201b and 201c are inserted along the third direction D3. The second connection opening 63 overlaps the first connection opening 44 in the third direction D3. The shield shell 24 includes a second opening 64, through which the wires 22a, 22b and 22c are passed in the second direction D2. The second opening 64 is located at the fourth end 62 of the shield shell 24. The second opening 64 overlaps the first opening 45 in the second direction D2.

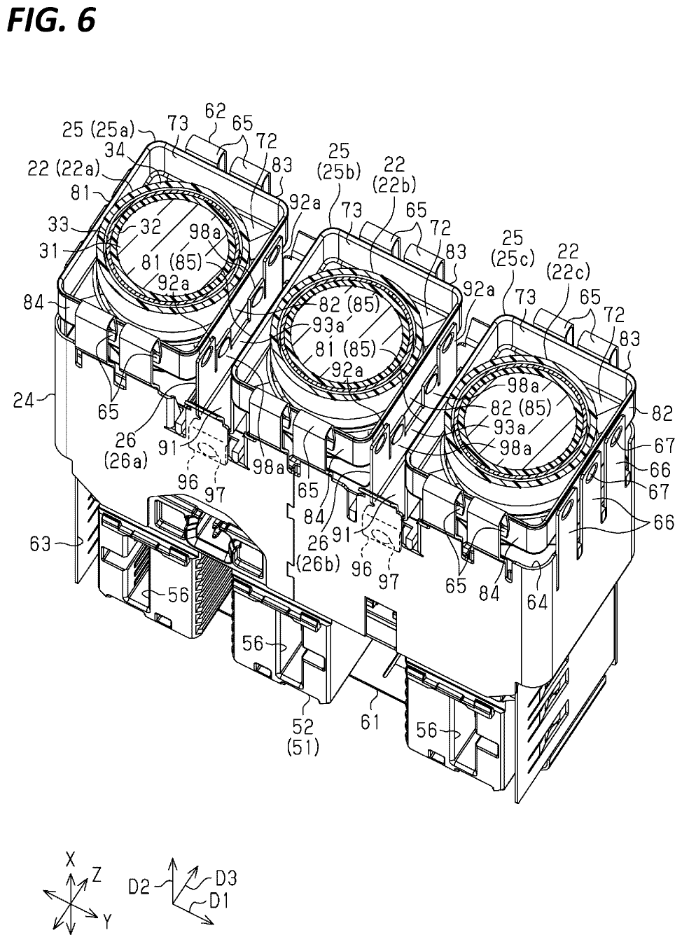

As shown in FIGS. 5 and 6, the shield shell 24 may include a plurality of first contact portions 65 in an end region including the fourth end 62. The plurality of first contact portions 65 are arranged along the peripheral edge of the second opening 64. For example, the shield shell 24 includes six first contact portions 65 on each of both ends in the third direction D3. The six first contact portions 65 located on an end part of the shield shell 24 in the third direction D3 are arranged in a row at intervals in the first direction D1. Similarly, the six first contact portions 65 located on an end part of the shield shell 24 in the direction opposite to the third direction D3 are arranged in a row at intervals in the first direction D1. The respective first contact portions 65 are formed, for example, by folding an end part of the shield shell 24 in the second direction D2 inwardly of the shield shell 24. Each first contact portion 65 is resilient.

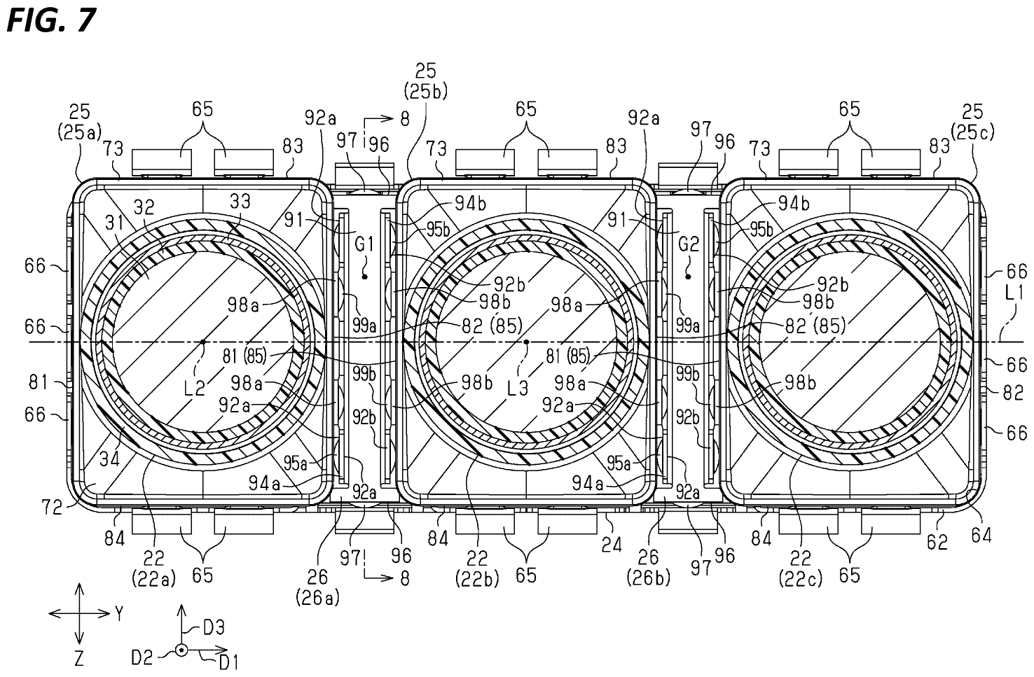

As shown in FIGS. 6 and 7, the shield shell 24 may include second contact portions 66 in an end region including the fourth end 62. For example, the shield shell 24 includes three second contact portions 66 on each of both ends in the first direction D1. The three second contact portions 66 located on an end part of the shield shell 24 in the first direction D1 are arranged in a row at intervals in the third direction D3. Similarly, the three second contact portions 66 located on an end part of the shield shell 24 in the direction opposite to the first direction D1 are arranged in a row at intervals in the third direction D3. Each second contact portion 66 is, for example, in the form of a cantilever extending in the second direction D2. In each second contact portion 66, an end part in the second direction D2 is a free end and an end part in the direction opposite to the second direction D2 is a fixed end. Each second contact portion 66 is resiliently deformable so that the free end is shifted along the first direction D1 with respect to the fixed end. Each second contact portion 66 may include a contact protrusion 67 projecting inwardly of the shield shell 24. The contact protrusion 67 is, for example, in the form of a projecting spherical surface.

### (Configuration of Shell Rings 25)

As shown in FIG. 3, the connector 20 includes three shell rings 25 including the shell rings 25a, 25b and 25c. The shell rings 25a, 25b and 25c are respectively mounted on the wires 22a, 22b and 22c. The shell rings 25a, 25b and 25c are arranged inside the connector housing 23. For example, the shell ring 25a is mounted on a part of the wire 22a arranged between the first opening 45 and the wire through opening 55a. Similarly, the shell ring 25b is mounted on a part of the wire 22b arranged between the first opening 45 and the wire through opening 55b. The shell ring 25c is mounted on a part of the wire 22c arranged between the first opening 45 and the wire through opening 55c. Further, the shell rings 25a, 25b and 25c are, for example, arranged inside the end region including the fourth end 62 in the shield shell 24. The shell rings 25a, 25b and 25c are arranged in the first direction D1.

Each of the shell rings 25a, 25b and 25c is electrically conductive. Each of shell rings 25a, 25b and 25c is, for example, formed by press-working a metal plate of copper alloy. Note that a material of the shell rings 25a, 25b and 25c is not limited to copper alloy, but may be a metal material such as copper, aluminum or aluminum alloy. The shell rings 25a, 25b and 25c have, for example, the same shape. In this embodiment, the shape of only the shell ring 25a is described in detail and detailed description on the shapes of the shell rings 25b, 25c is omitted.

As shown in FIG. 5, the shell ring 25a has an annular shape surrounding the outer periphery of the wire 22a. The shell ring 25a includes, for example, a fixing portion 71, an extending portion 72 and a contacted portion 73.

The fixing portion 71 has, for example, a circular ring shape. The wire 22a is passed through the fixing portion 71. The inner insulation coating 32 is exposed in a part of the wire 22a arranged inside the inner housing 51. For example, the outer insulation coating 34 is removed in a region from an end of the wire 22a in the direction opposite to the second direction D2 to a predetermined position between the wire through opening 55a and the second opening 64. The fixing portion 71 is mounted on the outer periphery of the electromagnetic shield member 33 exposed at a position between the wire through opening 55a and the second opening 64 in the second direction D2 inside the outer housing 41. The inner peripheral surface of the fixing portion 71 is in contact with the outer peripheral surface of the electromagnetic shield member 33. Further, the electromagnetic shield member 33 includes a folded portion 33a folded in the second direction D2 in an end region in the direction opposite to the second direction D2. The folded portion 33a is overlapped on the fixing portion 71 to cover the outer peripheral surface of the fixing portion 71.

For example, the connector 20 includes a fixing member 75 for fixing the shell ring 25a to the wire 22a. The fixing member 75 is mounted on the outer periphery of the folded portion 33a. The fixing member 75 has, for example, an annular shape. The fixing member 75 fixes the shell ring 25a to the wire 22a by tightening the folded portion 33a, the fixing portion 71 and a part of the wire 22a arranged inside the fixing portion 71. Further, by pressing the fixing portion 71 against the electromagnetic shield member 33 of the wire 22a by the fixing member 75, the fixing portion 71 and the electromagnetic shield member 33 are electrically connected. That is, the shell ring 25a is electrically connected to the electromagnetic shield member 33 of the wire 22a at the fixing portion 71. The fixing member 75 is, for example, a crimp ring made of metal. The fixing member 75 is, for example, crimped to have a hexagonal outer shape when viewed from the second direction D2.

Note that the shell ring 25b is fixed to the wire 22b and electrically connected to the electromagnetic shield member 33 of the wire 22b in a similar manner. Further, the shell ring 25c is fixed to the wire 22c and electrically connected to the electromagnetic shield member 33 of the wire 22c in a similar manner.

As shown in FIGS. 5, 6 and 7, the extending portion 72 extends outwardly of the fixing portion 71 from the fixing portion 71. For example, the extending portion 72 extends outward from an end part in the second direction D2 of the fixing portion 71. For example, the outer edge of the extending portion 72 is located at a position shifted in the second direction D2 from the inner edge of the extending portion 72. Thus, the extending portion 72 is inclined with respect to a plane perpendicular to the second direction D2. For example, when viewed from the second direction D2, the inner edge of the extending portion 72 has a circular shape, whereas the outer edge of the extending portion 72 has a rectangular shape.

The contacted portion 73 extends in the second direction D2 from the outer edge of the extending portion 72. Incidentally, the extending portion 72 covers a part between the fixing portion 71 and the extending portion 72. The contacted portion 73 has, for example, an annular shape surrounding the outer periphery of the wire 22a. Further, the contacted portion 73 extends, for example, in parallel to the second direction D2. For example, the contacted portion 73 has a rectangular frame shape when viewed from the second direction D2. Thus, the outer shape of the shell ring 25a has, for example, a rectangular shape when viewed from the second direction D2.

As shown in FIGS. 6 and 7, the outer peripheral surface of the contacted portion 73 constitutes a part of the outer peripheral surface of the shell ring 25. The outer peripheral surface of the contacted portion 73 is, for example, parallel to the second direction D2. The outer peripheral surface of the contacted portion 73 has, for example, four side surfaces including a first side surface 81, a second side surface 82, a third side surface 83 and a fourth side surface 84. The outer peripheral surface of the contacted portion 73 has a rectangular tube shape constituted by the first, second, third and fourth side surfaces 81, 82, 83 and 84. The first side surface 81 is an outer side surface of the contacted portion 73 in the direction opposite to the first direction D1. The second side surface 82 is an outer side surface of the contacted portion 73 in the first direction D1. Each of the first and second side surfaces 81, 82 is, for example, a flat surface perpendicular to the first direction D1. The third side surface 83 is an outer side surface of the contacted portion 73 in the third direction D3. The fourth side surface 84 is an outer side surface of the contacted portion 73 in the direction opposite to the third direction D3. The third and fourth side surfaces 83, 84 are, for example, parallel to the first direction D1 when viewed from the second direction D2. The third and fourth side surfaces 83, 84 are, for example, flat surfaces perpendicular to the third direction D3.

Two first contact portions 65 arranged on the end in the direction opposite to the first direction D1, out of the six first contact portions 65 located on the end part of the shield shell 24 in the third direction D3 are in contact with the third side surface 83 of the shell ring 25a. These two first contact portions 65 press the third side surface 83 in the direction opposite to the third direction D3 by resilient forces thereof. Two first contact portions 65 arranged on the end in the direction opposite to the first direction D1, out of the six first contact portions 65 located on the end part of the shield shell 24 in the direction opposite to the third direction D3 are in contact with the fourth side surface 84 of the shell ring 25a. These two first contact portions 65 press the fourth side surface 84 in the third direction D3 by resilient forces thereof. Further, three second contact portions 66 located on an end part of the shield shell 24 in the direction opposite to the first direction D1 are in contact with the first side surface 81 of the shell ring 25a. These three second contact portions 66 press the contact protrusions 67 against the first side surface 81 by resilient forces thereof.

In this way, the first and second contact portions 65, 66 contact the shell ring 25a, whereby the shell ring 25a and the shield shell 24 are electrically connected. Then, the shell ring 25a electrically connects the electromagnetic shield member 33 of the wire 22a having the shell ring 25a mounted thereon and the shield shell 24.

Similarly, two middle first contact portions 65, out of the six first contact portions 65 located on the end part of the shield shell 24 in the third direction D3 are in contact with the third side surface 83 of the shell ring 25b. These two first contact portions 65 press the third side surface 83 in the direction opposite to the third direction D3 by resilient forces thereof. Two middle first contact portions 65, out of the six first contact portions 65 located on the end part of the shield shell 24 in the direction opposite to the third direction D3 are in contact with the fourth side surface 84 of the shell ring 25b. These two first contact portions 65 press the fourth side surface 84 in the third direction D3 by resilient forces thereof. In this way, the first contact portions 65 contact the shell ring 25b, whereby the shell ring 25b and the shield shell 24 are electrically connected. Then, the shell ring 25b electrically connects the electromagnetic shield member 33 of the wire 22b having the shell ring 25b mounted thereon and the shield shell 24.

Further similarly, two first contact portions 65 arranged on the end in the first direction D1, out of the six first contact portions 65 located on the end part of the shield shell 24 in the third direction D3 are in contact with the third side surface 83 of the shell ring 25c. These two first contact portions 65 press the third side surface 83 in the direction opposite to the third direction D3 by resilient forces thereof. Two first contact portions 65 arranged on the end in the first direction D1, out of the six first contact portions 65 located on the end part of the shield shell 24 in the direction opposite to the third direction D3 are in contact with the fourth side surface 84 of the shell ring 25c. These two first contact portions 65 press the fourth side surface 84 in the third direction D3 by resilient forces thereof. Further, three second contact portions 66 located on the end part of the shield shell 24 in the first direction D1 are in contact with the second side surface 82 of the shell ring 25c. These three second contact portions 66 press the contact protrusions 67 against the second side surface 82 by resilient forces thereof. In this way, the first and second contact portions 65, 66 contact the shell ring 25c, whereby the shell ring 25c and the shield shell 24 are electrically connected. Then, the shell ring 25c electrically connects the electromagnetic shield member 33 of the wire 22c having the shell ring 25c mounted thereon and the shield shell 24.

As shown in FIG. 7, a gap G1 is present between the shell rings 25a and 25b adjacent in the first direction D1 when viewed from the second direction D2. Further, a gap G2 is present between the shell rings 25b and 25c adjacent in the first direction D1 when viewed from the second direction D2. The second side surface 82 of the shell ring 25 and the first side surface 81 of the shell ring 25b are facing each other across the gap G1 in the first direction D1. The second side surface 82 of the shell ring 25b and the first side surface 81 of the shell ring 25c are facing each other across the gap G2 in the first direction D1.

### (Configuration of Shield Attachments 26)

As shown in FIG. 3, the connector 20 is, for example, provided with two shield attachments 26 including shield attachments 26a, 26b. Note that the shield attachments 26, 26a, 26b are written as “attachments 26, 26a, 26b” below. The attachment 26a is arranged between the shell rings 25a and 25b adjacent in the first direction D1. That is, the attachment 26a is arranged in the gap G1. The attachment 26b is arranged between the shell rings 25b and 25c adjacent in the first direction D1. That is, the attachment 26b is arranged in the gap G2. Further, the attachments 26a, 26b are arranged between the terminals 21a, 21b and 21c and the first opening 45 in the X-axis direction.

Each of the attachments 26a, 26b is electrically conductive. Each of the attachments 26a, 26b is, for example, formed by press-working a metal plate of copper alloy. Note that a material of the attachments 26a, 26b is not limited to copper alloy, but may be a metal material such as copper, aluminum or aluminum alloy. The attachments 26a, 26b have, for example, the same shape. Accordingly, the shape of only the attachment 26a is described in detail and detailed description on the shape of the attachment 26b is omitted in this embodiment.

As shown in FIGS. 6 and 7, the attachment 26a includes a covering portion 91, first pressing portions 92a and second pressing portions 92b.

The covering portion 91 is located inside the second opening 64 when viewed from the second direction D2 and covers the gap G1. The covering portion 91 is, for example, in the form of a flat plate perpendicular to the second direction D2. For example, the covering portion 91 is in the form of a rectangular plate having a width corresponding to a width of the gap G1 in the first direction D1.

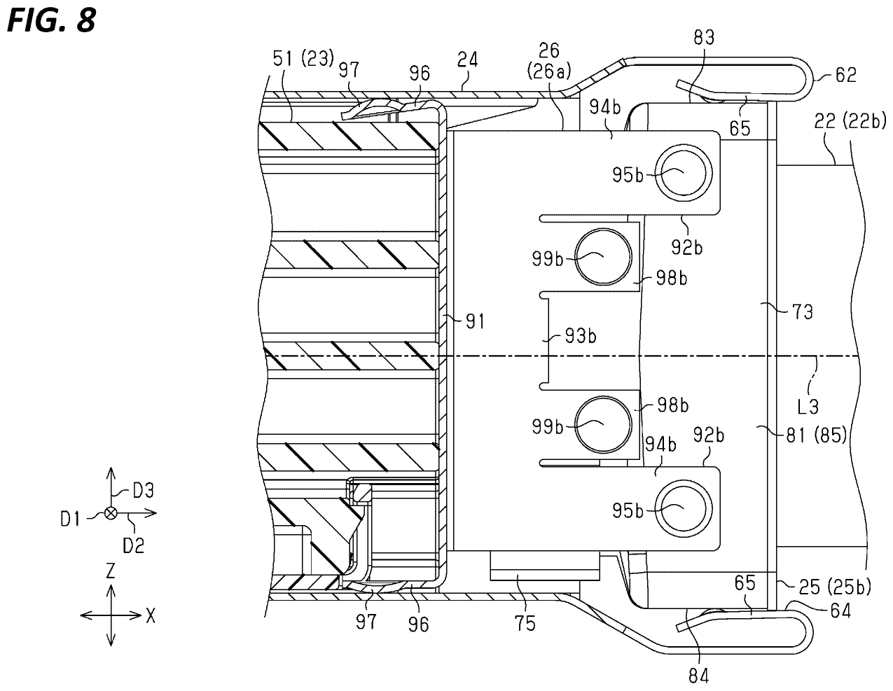

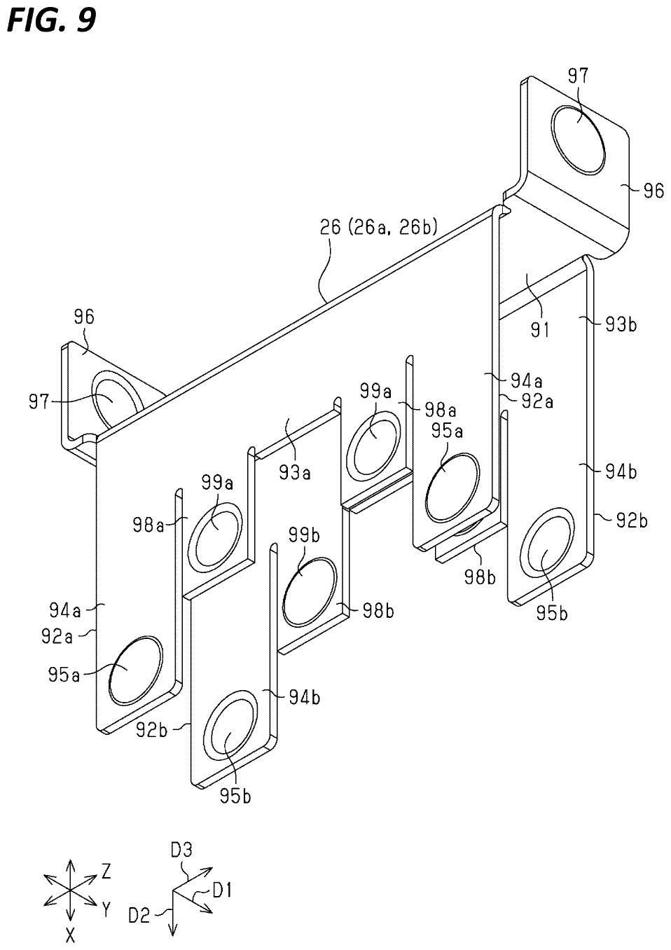

As shown in FIGS. 8 and 9, the attachment 26a includes, for example, a first extending portion 93a extending in the second direction D2 from an end part of the covering portion 91 in the direction opposite to the first direction D1. Further, the attachment 26a includes, for example, a second extending portion 93b extending in the second direction D2 from an end part of the covering portion 91 in the first direction D1. Note that FIG. 8 is a section along 8-8 in FIG. 7. The first pressing portions 92a extend, for example, along the second direction D2 from the first extending portion 93a. The second pressing portions 92b extend, for example, along the second direction D2 from the second extending portion 93b.

As shown in FIG. 7, the attachment 26a includes, for example, the first pressing portions 92a on both sides of a virtual straight line L1 passing through centers of the wires 22a, 22b and 22c when viewed from the second direction D2. Further, the attachment 26a includes, for example, the second pressing portions 92b on the both sides of the virtual straight line L1 when viewed from the second direction D2. That is, the attachment 26a includes the first and second pressing portions 92a, 92b on the both sides of the virtual straight line L1 in the third direction D3 when viewed from the second direction D2.

As shown in FIGS. 7 and 9, each first pressing portion 92a includes, for example, a leaf spring portion 94a and a contact protrusion 95a projecting from the surface of the leaf spring portion 94a. The leaf spring portion 94a extends in the second direction D2 from the first extending portion 93a. The leaf spring portion 94a is resiliently deformable so that a tip is shifted along the first direction D1 with respect to the base end thereof. The contact protrusion 95a projects in the direction opposite to the first direction D1 from the leaf spring portion 94a. The contact portion 95a has, for example, a spherical surface. Each first pressing portion 92a contacts the second side surface 82 of the shell ring 25a adjacent to the attachment 26a in the first direction D1 and presses the second side surface 82 with a force including a component in a direction parallel to the first direction D1. In the shell ring 25a, the second side surface 82 is a contact surface 85 to be contacted by the first pressing portions 92a of the attachment 26a. That is, the contact surface 85 contacts the attachment 26a. Two first pressing portions 92a press the second side surface 82 of the shell ring 25a on the both sides of the virtual straight line L1 in the third direction D3 when viewed from the second direction D2. Further, the two first pressing portions 92a press the second side surface 82 of the shell ring 25a on both sides of a center line L2 of the wire 22a in the third direction D3 when viewed from the first direction D1. The contact protrusion 95a of each first pressing portion 92a is pressed against the second side surface 82 of the shell ring 25a by a resilient force of the leaf spring portion 94a. The attachment 26a is electrically connected to the shell ring 25a by the contact of the first pressing portions 92a with the second side surface 82 of the shell ring 25a. Then, the attachment 26a is electrically connected to the shield shell 24 via the shell ring 25a.

As shown in FIGS. 7, 8 and 9, each second pressing portion 92b includes, for example, a leaf spring portion 94b and a contact protrusion 95b projecting from the surface of the leaf spring portion 94b. The leaf spring portion 94b extends in the second direction D2 from the second extending portion 93b. The leaf spring portion 94b is resiliently deformable so that a tip is shifted along the first direction D1 with respect to the base end thereof. The contact protrusion 95b projects in the first direction D1 from the leaf spring portion 94b. The contact portion 95b has, for example, a spherical surface. Each second pressing portion 92b contacts the first side surface 81 of the shell ring 25b adjacent to the attachment 26a in the first direction D1 and presses the first side surface 81 with a force including a component in a direction parallel to the first direction D1. In the shell ring 25b, the first side surface 81 is a contact surface 85 to be contacted by the second pressing portions 92b of the attachment 26a. That is, the contact surface 85 contacts the attachment 26a. Two second pressing portions 92b press the first side surface 81 of the shell ring 25b on the both sides of the virtual straight line L1 in the third direction D3 when viewed from the second direction D2. Further, the two second pressing portions 92b press the first side surface 81 of the shell ring 25b on both sides of a center line L3 of the wire 22b in the third direction D3 when viewed from the first direction D1. The contact protrusion 95b of each second pressing portion 92b is pressed against the first side surface 81 of the shell ring 25b by a resilient force of the leaf spring portion 94b. The attachment 26a is electrically connected to the shell ring 25b by the contact of the second pressing portions 92b with the first side surface 81 of the shell ring 25b. Then, the attachment 26a is electrically connected to the shield shell 24 also via the shell ring 25b.

As just described, the first and second pressing portions 92a, 92b of the attachment 26a press the contact surfaces 85 of the shell rings 25a, 25b located on both sides of the attachment 26a in the first direction D1 on the both sides of the virtual straight line L1 in the third direction D3.

The attachment 26a may include contact portions 96 to be held in contact with the shield shell 24. For example, the attachment 26a includes the contact portions 96 on both ends of the covering portion 91 in the third direction D3. For example, the contact portions 96 extend in the direction opposite to the second direction D2 from the both ends of the covering portion 91 in the third direction D3. The contact portion 96 is resiliently deformable so that a tip is shifted along the third direction D3 with respect to the base end thereof. The contact portion 96 may include a contact protrusion 97 to be pressed against the inner peripheral surface of the shield shell 24 by a resilient force of the contact portion 96. The attachment 26a is electrically connected to the shield shell 24 also at the contact portions 96 by the contact of the contact protrusions 97 of the contact portions 96 with the inner peripheral surface of the shield shell 24.

The attachment 26a includes, for example, two first engaging portions 98a. Note that one, three or more first engaging portions 98a may be provided. The two first engaging portions 98a extend in the second direction D2 from the first extending portion 93a between the two first pressing portions 92a. The two first engaging portions 98a are separated from each other in the third direction D3. Each first engaging portion 98a is resiliently deformable so that a tip is shifted along the first direction D1 with respect to the base end thereof. Each first engaging portion 98a includes, for example, a first engaging protrusion 99a projecting in the first direction D1 from each first engaging portion 98a. The first engaging protrusion 99a has, for example, a spherical surface.

Further, the attachment 26a includes, for example, two second engaging portions 98b. Note that one, three or more second engaging portions 98b may be provided. The two second engaging portions 98b extend in the second direction D2 from the second extending portion 93b between the two second pressing portions 92b. The two second engaging portions 98b are separated from each other in the third direction D3. Each second engaging portion 98b is resiliently deformable so that a tip is shifted along the first direction D1 with respect to the base end thereof. Each second engaging portion 98b includes, for example, a second engaging protrusion 99b projecting in the direction opposite to the first direction D1 from each second engaging portion 98b. The second engaging protrusion 99b has, for example, a spherical surface.

As shown in FIGS. 6 and 7, similarly to the attachment 26a, first and second pressing portions 92a, 92b of the attachment 26b also contact the shell rings 25b, 25c located on both sides of the attachment 26b in the first direction D1. That is, the respective first pressing portions 92a of the attachment 26b contact the second side surface 82 of the shell ring 25b adjacent to the attachment 26b in the first direction D1 and press the second side surface 82 with forces including components in the direction parallel to the first direction D1. In the shell ring 25b, the second side surface 82 is a contact surface 85 to be contacted by the first pressing portions 92a of the attachment 26b. The two first pressing portions 92a of the attachment 26b press the second side surface 82 of the shell ring 25b on the both sides of the virtual straight line L1 in the third direction D3 when viewed from the second direction D2. Contact protrusions 95a of the respective first pressing portions 92a of the attachment 26b are pressed against the second side surface 82 of the shell ring 25b by resilient forces of leaf spring portions 94a. The attachment 26b is electrically connected to the shell ring 25b by the contact of the first pressing portions 92a with the second side surface 82 of the shell ring 25b. Then, the attachment 26b is electrically connected to the shield shell 24 via the shell ring 25b.

Further, the respective second pressing portions 92b of the attachment 26b contact the first side surface 81 of the shell ring 25c adjacent to the attachment 26b in the first direction D1 and press the first side surface 81 with forces including components in the direction parallel to the first direction D1. In the shell ring 25c, the first side surface 81 is a contact surface 85 to be contacted by the second pressing portions 92b of the attachment 26b. The two second pressing portions 92b of the attachment 26b press the first side surface 81 of the shell ring 25c on the both sides of the virtual straight line L1 in the third direction D3 when viewed from the second direction D2. Contact protrusions 95b of the respective second pressing portions 92b of the attachment 26b are pressed against the first side surface 81 of the shell ring 25c by resilient forces of leaf spring portions 94b. The attachment 26b is electrically connected to the shell ring 25c by the contact of the second pressing portions 92b with the first side surface 81 of the shell ring 25c. Then, the attachment 26b is electrically connected to the shield shell 24 also via the shell ring 25c.

As just described, the first and second pressing portions 92a, 92b of the attachment 26b press the contact surfaces 85 of the shell rings 25b, 25c located on both sides of the attachment 26b in the first direction D1 on the both sides of the virtual straight line L1 in the third direction D3. Further, the attachment 26b is electrically connected to the shield shell 24 also at contact portions 96 by the contact of contact protrusions 97 of the contact portions 96 with the inner peripheral surface of the shield shell 24.

As shown in FIG. 7, the second opening 64 of the shield shell 24 is closed by the wires 22a, 22b, the shell rings 25a, 25b and 25c and the attachments 26a, 26b when viewed from the second direction D2. That is, a gap between the inner edge of the second opening 64 and the outer peripheral surfaces of the respective wires 22a, 22b and 22c is closed by the shell rings 25a, 25b and 25c and the attachments 26a, 26b.

### (Configuration of Back Retainer Holder 101)

As shown in FIGS. 2 and 5, the connector 20 is, for example, provided with a back retainer holder 101 to be mounted into the first opening 45. The back retainer holder 101 is, for example, made of synthetic resin.

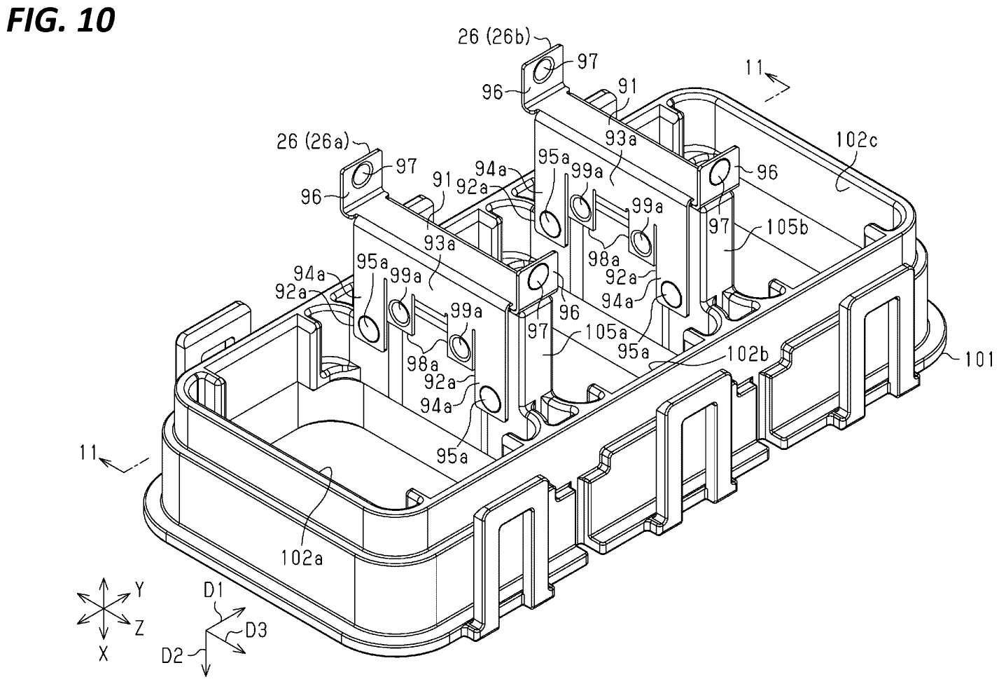

As shown in FIGS. 3 and 10, the back retainer holder 101 has an outer shape fittable into the first opening 45. The back retainer holder 101 prevents the inner housing 51 from coming out from the outer housing 41 through the first opening 45.

For example, the back retainer holder 101 includes a through hole 102a, through which the wire 22a is passed in the second direction D2, a through hole 102b, through which the wire 22b is passed in the second direction D2, and a through hole 102c, through which the wire 22c is passed in the second direction D2. The through holes 102a, 102b and 102c are arranged in the first direction D1.

The connector 20 is further provided with a first sealing member 103a for sealing between the inner peripheral surface of the through hole 102a and the outer peripheral surface of the wire 22a. The connector 20 may be further provided with a first sealing member 103b for sealing between the inner peripheral surface of the through hole 102b and the outer peripheral surface of the wire 22b and a first sealing member 103c for sealing between the inner peripheral surface of the through hole 102c and the outer peripheral surface of the wire 22c. The first sealing member 103a, 103b, 103c has, for example, an annular shape surrounding the outer periphery of the wire 22a, 22b, 22c when viewed from the second direction D2. Each of the first sealing members 103a, 103b, 103c is, for example, a rubber ring. The first sealing member 103a suppresses the intrusion of a liquid such as water into the inside of the outer housing 41 between the outer peripheral surface of the wire 22a and the inner peripheral surface of the through hole 102a. The first sealing member 103b suppresses the intrusion of a liquid such as water into the inside of the outer housing 41 between the outer peripheral surface of the wire 22b and the inner peripheral surface of the through hole 102b. The first sealing member 103c suppresses the intrusion of a liquid such as water into the inside of the outer housing 41 between the outer peripheral surface of the wire 22c and the inner peripheral surface of the through hole 102c.

As shown in FIGS. 3 and 5, the connector 20 may be further provided with a second sealing member 104 between the outer peripheral surface of the back retainer holder 101 and the inner peripheral surface of the outer housing 41. The second sealing member 104 has an annular shape surrounding the outer periphery of the back retainer holder 101. The second sealing member 104 is, for example, a rubber ring. The second sealing member 104 is interposed between the inner peripheral surface of the outer housing 41 and the outer peripheral surface of the back retainer holder 101. The second sealing member 104 suppresses the intrusion of a liquid such as water into the inside of the outer housing 41 between the outer peripheral surface of the back retainer holder 101 and the inner peripheral surface of the outer housing 41. That is, the second sealing member 104 suppresses the intrusion of a liquid such as water into the inside of the outer housing 41 through the first opening 45.

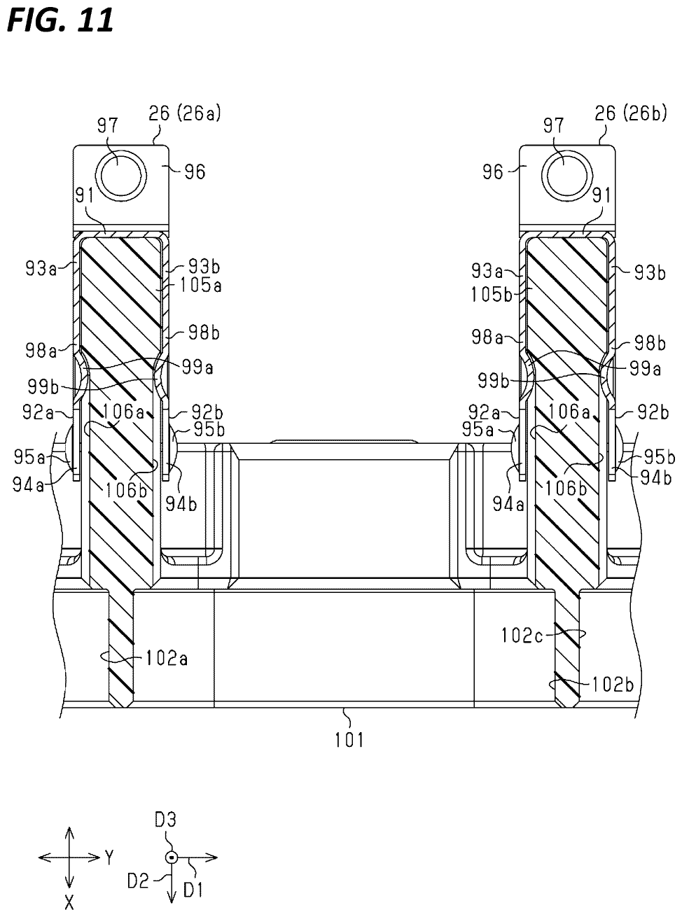

As shown in FIGS. 10 and 11, the back retainer holder 101 may include a mounting portion 105a, on which the attachment 26a is mounted, and a mounting portion 105b, on which the attachment 26b is mounted. Note that FIG. 11 is a section along 11-11 in FIG. 10. The mounting portion 105a projects in the direction opposite to the second direction D2 from a part of the back retainer holder 101 between the through holes 102a and 102b. The mounting portion 105b projects in the direction opposite to the second direction D2 from a part of the back retainer holder 101 between the through holes 102b and 102c. Note that since the mounting portion 105b has the same shape as the mounting portion 105a, detailed description on the mounting portion 105b is omitted.

The mounting portion 105a includes, for example, first engaging recesses 106 in an end surface in the direction opposite to the first direction D1. Further, the mounting portion 105a includes, for example, second engaging recesses 106b in an end surface in the first direction D1. The first engaging recess 106a is recessed in the first direction D1. The second engaging recess 106b is recessed in the direction opposite to the first direction D1.

The attachment 26a is arranged on the mounting portion 105a to sandwich a tip region of the mounting portion 105a between the first and second extending portions 93a, 93b. The first engaging protrusions 99a are arranged in the first engaging recesses 106a and the second engaging protrusions 99b are arranged in the second engaging recesses 106b, whereby the attachment 26a is mounted on the back retainer holder 101. The detachment of the attachment 26a from the mounting portion 105a is suppressed by the contact of the first engaging protrusions 99a with the inner surfaces of the first engaging recesses 106a and the contact of the second engaging protrusions 99b with the inner surfaces of the second engaging recesses 106b. The attachment 26b is mounted on the mounting portion 105b in a mounting mode similar to that of the attachment 26a on the mounting portion 105a.

The back retainer holder 101 is mounted in the first opening 45 with the attachments 26a, 26b mounted. That is, the attachments 26a, 26b are arranged between the shell rings 25a, 25b and 25c adjacent in the first direction D1 while being mounted on the back retainer holder 101. For example, the fixing members 75 located on both sides of the attachment 26a in the first direction D1 contact the attachment 26a. Further, for example, the fixing members 75 located on both sides of the attachment 26b in the first direction D1 contact the attachment 26b.

Note that, as shown in FIGS. 1, 2 and 5, the connector 20 may include a back retainer 111 to be mounted in an end region including the second end 43 in the outer housing 41. The back retainer 111 prevents the detachment of the first sealing members 103a, 103b and 103c from the first opening 45. Further, the back retainer 111 prevents the detachment of the back retainer holder 101 from the outer housing 41. The back retainer 111 is, for example, composed of divided retainers 112a, 112b divided into two in the third direction D3. Each of the wires 22a, 22b and 22c is passed through the back retainer 111 in the second direction D2 and pulled to the outside of the outer housing 41.

### (Functions and Effects of Embodiment)

Functions and effects of this embodiment are described.
(1) The connector 20 is provided with the plurality of terminals 21 arranged in the first direction D1 and the plurality of wires 22 to be electrically connected to the plurality of terminals 21. Further, the connector 20 includes the connector housing 23 for holding the plurality of terminals 21 inside, the connector housing 23 having the first opening 45, through which the plurality of wires 22 are passed in the second direction D2 intersecting the first direction D1, and the electrically conductive shield shell 24 for covering the plurality of terminals 21. Further, the connector 20 is provided with the plurality of shell rings 25 respectively mounted on the plurality of wires 22 and arranged in the first direction D1 and the electrically conductive attachments 26 arranged between the shell rings 25 adjacent in the first direction D1. The shield shell 24 includes the second opening 64, through which the plurality of wires 22 are passed in the second direction D2. Each of the plurality of wires 22 is the shielded wire including the core wire 31, the inner insulation coating 32 covering the outer periphery of the core wire 31 and the electrically conductive electromagnetic shield member 33 covering the outer periphery of the inner insulation coating 32. Each of the plurality of shell rings 25 electrically connects the electromagnetic shield member 33 of the wire 22 having the shell ring 25 mounted thereon and the shield shell 24. The outer peripheral surface of each of the plurality of shell rings 25 has the contact surface 85 to be held in contact with the attachment 26. The attachment 26a includes the covering portion 91 located inside the second opening 64 when viewed from the second direction D2 and configured to cover the gap G1 between the shell rings 25a and 25b adjacent in the first direction D1. Further, the attachment 26a includes the first and second pressing portions 92a, 92b to be held in contact with the contact surfaces 85 of the shell rings 25a, 25b adjacent to the attachment 26a in the first direction D1 and configured to press the contact surfaces 85 with forces including components in the direction parallel to the first direction D1. The attachment 26b includes the covering portion 91 located inside the second opening 64 when viewed from the second direction D2 and configured to cover the gap G1 between the shell rings 25b and 25c adjacent in the first direction D1. Further, the attachment 26b includes the first and second pressing portions 92a, 92b to be held in contact with the contact surfaces 85 of the shell rings 25b, 25c adjacent to the attachment 26b in the first direction D1 and configured to press the contact surfaces 85 with forces including components in the direction parallel to the first direction D1.

According to this configuration, the attachment 26a is electrically connected to the shell rings 25a, 25b by the contact of the first and second pressing portions 92a, 92b thereof with the contact surfaces 85. Then, electromagnetic noise emitted from the wires 22 and the terminals 21 can be suppressed from leaking to the outside of the connector 20 through the gap G1 between the shell rings 25a and 25b adjacent in the first direction D1 by the covering portion 91 of the shell ring 25a. Further, the attachment 26b is electrically connected to the shell rings 25b, 25c by the contact of the first and second pressing portions 92a, 92b thereof with the contact surfaces 85. Then, electromagnetic noise emitted from the wires 22 and the terminals 21 can be suppressed from leaking to the outside of the connector 20 through the gap G2 between the shell rings 25b and 25c adjacent in the first direction D1 by the covering portion 91 of the shell ring 25b. Therefore, even if the shell rings 25a, 25b adjacent in the first direction D1 and the shell rings 25b, 25c adjacent in the first direction D1 are arranged apart in the first direction D1 to be compatible with larger currents carried in the wires 22, the electromagnetic shielding performance of the connector 20 can be ensured.

Further, the first and second pressing portions 92a, 92b press the contact surfaces 85 with the forces including the components in the direction parallel to the first direction D1. Thus, the shell rings 25 become less likely to vibrate in the first direction D1. Accordingly, the vibration in the first direction D1 of the wires 22 having the shell rings 25 mounted thereon can be suppressed. As a result, the vibration of the connector 20 due to the vibration of the wires 22 can be suppressed. Generally, as the wire 22 becomes thicker to carry a current having a larger current value and a larger voltage value, it becomes difficult to suppress the vibration of the wire 22. Accordingly, if the vibration of the wires 22 is suppressed by suppressing the vibration of the shell rings 25 as in this embodiment, this can contribute to suppressing the vibration of the connector 20. Further, by suppressing the vibration of the shell rings 25, it can be suppressed that the electrical connection of the shell rings 25 and the shield shell 24 becomes unstable.
(2) The first and second pressing portions 92a, 92b press the contact surfaces 85 of the shell rings 25 located on the both sides of the attachment 26 in the first direction D1 on the both sides of the virtual straight line LI passing through the centers of the plurality of wires 22 when viewed from the second direction D2.

According to this configuration, the attachment 26 can contact the shell ring 25 at a plurality of positions. Thus, the electrical connection of the attachment 26 and the shell ring 25 is stabilized as compared to the case where the attachment 26 and the adjacent shell ring 25 are in contact at one position. Further, the vibration of the shell rings 25 is more easily suppressed as compared to the case where the attachment 26 presses the shell rings 25 adjacent thereto only at one position by the first and second pressing portions 92a, 92b. Therefore, the vibration of the wires 22 in the first direction D1 can be more suppressed.
(3) The attachment 26 includes the contact portions 96 to be held in contact with the shield shell 24. According to this configuration, the attachment 26 can be not only electrically connected to the shield shell 24 indirectly via the shell rings 25, but also electrically connected to the shield shell 24 directly by the contact of the contact portions 96 with the shield shell 24. Thus, the attachment 26 can be more stably electrically connected to the shield shell 24. Therefore, electromagnetic shielding performance can be ensured in the attachment 26.
(4) The first pressing portion 92a includes the leaf spring portion 94a and the contact protrusion 95a projecting from the surface of the leaf spring portion 94a and to be pressed against the contact surface 85 by a resilient force of the leaf spring portion 94a. The second pressing portion 92b includes the leaf spring portion 94b and the contact protrusion 95b projecting from the surface of the leaf spring portion 94b and to be pressed against the contact surface 85 by a resilient force of the leaf spring portion 94b.

According to this configuration, since being shaped to project from the leaf spring portion 94a, the contact protrusion 95a easily contacts the contact surface 85. Since the contact protrusion 95a is pressed against the contact surface 85 by the resilient force of the leaf spring portion 94a, the first pressing portion 92a is easily maintained in contact with the contact surface 85. Similarly, since being shaped to project from the leaf spring portion 94b, the contact protrusion 95b easily contacts the contact surface 85. Since the contact protrusion 95b is pressed against the contact surface 85 by the resilient force of the leaf spring portion 94b, the first pressing portion 92b is easily maintained in contact with the contact surface 85. Therefore, the electrical connection of the shell rings 25 and the attachment 26 can be stabilized.
(5) The contact surface 85 is a flat surface perpendicular to the first direction D1. According to this configuration, a force in the direction parallel to the first direction D1 can be easily applied to the shell ring 25 from the first pressing portion 92a, for example, by the first pressing portion 92a pressing the contact surface 85. Further, a force in the direction parallel to the first direction D1 can be easily applied to the shell ring 25 from the second pressing portion 92b, for example, by the second pressing portion 92b pressing the contact surface 85. Thus, the vibration of the shell ring 25 in the first direction D1 can be more suppressed. Therefore, the vibration of the wire 22 in the first direction D1 can be even more suppressed.
(6) Each of the plurality of shell rings 25 has the rectangular outer shape when viewed from the second direction D2. The outer peripheral surface of each of the shell rings 25 has two surfaces parallel to the first direction D1 and two surfaces perpendicular to the first direction D1 when viewed from the second direction D2. The contact surface 85 is included in the surface perpendicular to the first direction D1, out of the peripheral surface of each of the plurality of shell rings 25.

According to this configuration, it can be suppressed that the shapes of the gaps G1, G2 between the shell rings 25 adjacent in the first direction D1 become complicated. Accordingly, it can be suppressed that the shapes of the covering portions 91 for covering these gaps G1, G2 become complicated, whereby it can be suppressed that the shapes of the attachments 26 become complicated. As a result, the manufacturing of the attachments 26 is facilitated. Further, since the gaps G1, G2 between the shell rings 25 adjacent in the first direction D1 can be easily covered by the covering portions 91, the electromagnetic shielding performance of the connector 20 can be easily ensured.
(7) The connector 20 is further provided with the back retainer holder 101 to be mounted into the first opening 45 and including the through holes 102a, 102b and 102c, through which the plurality of wires 22 are passed in the second direction D2. The connector 20 is further provided with the first sealing members 103a, 103b and 103c for sealing between the outer peripheral surfaces of the plurality of respective wires 22 and the inner peripheral surfaces of the through holes 102a, 102b and 102c. The attachments 26 are arranged between the shell rings 25 adjacent in the first direction D1 while being mounted on the back retainer holder 101.

According to this configuration, in assembling the connector 20, the back retainer holder 101 having the attachments 26 mounted thereon can be mounted into the first opening 45. By doing so, the attachments 26 can be easily arranged between the shell rings 25 adjacent in the first direction D1 as compared to the case where the attachments 26 are singly inserted between the shell rings 25 adjacent in the first direction D1. Further, since the attachments 26 are mounted on the back retainer holder 101, position shifts of the attachments 26 inside the connector 20 can be suppressed.

This embodiment can be modified and carried out as follows. This embodiment and the following modifications can be carried out in combination without technically contradicting each other.
In the above embodiment, the mounting mode of the attachments 26a, 26b on the back retainer holder 101 is not limited to that of the above embodiment. For example, the attachment 26a, 26b may include first and second engaging holes in the first and second engaging portions 98a, 98b, instead of the first and second engaging protrusions 99a, 99b. The back retainer holder 101 may include first and second engaging protrusions to be fit into the first and second engaging holes, instead of the first and second engaging recesses 106a, 106b. Further, for example, the attachments 26a, 26b may be integrated with the back retainer holder 101 by insert molding. Further, for example, the attachments 26a, 26b may be mounted on the back retainer holder 101 by adhesion.

Note that the attachments 26a, 26b may not necessarily be mounted on the back retainer holder 101. In this case, a step of arranging the attachments 26 between the shell rings 25 adjacent in the first direction and a step of mounting the back retainer holder 101 into the first opening 45 are separately performed during the manufacturing of the connector 20.
The shape of the back retainer holder 101 is not limited to that of the above embodiment. For example, the back retainer holder 101 may include one through hole, through which the plurality of wires 22 are passed in the second direction D2, instead of the through holes 102a, 102b and 102c.
The shape of the shell ring 25 is not limited to that of the above embodiment. The shell ring 25 only has to be shaped to have the contact surface 85 on the outer peripheral surface. The contact surface 85 only has to be a surface intersecting the first direction D1. For example, the outer shape of the shell ring 25 may be any shape such as a polygonal shape other than a rectangular shape, a circular shape, a rectangular shape with round corners or another arbitrary shape. Further, for example, the shape of the contacted portion 73 when viewed from the second direction D2 may be any shape such as a polygonal shape other than a rectangular shape, a circular shape, a rectangular shape with round corners or another arbitrary shape. Further, the outer peripheral surface of the contacted portion 73 may be inclined with respect to the second direction D2. For example, the outer shape of the contacted portion 73 may become larger or smaller from an end part in the direction opposite to the second direction D2 toward an end part in the second direction D2. The contact surface 85 to be pressed by the first or second pressing portions 92a, 92b may be included in the outer peripheral surface of such a contacted portion 73.
The contact surface 85 may be, for example, a curved surface or an irregular surface without being limited to the flat surface.
The first pressing portion 92a may not include the contact protrusion 95a. The second pressing portion 92b may not include the contact protrusion 95b.
The attachment 26 may not include the contact portions 96. ·The number and positions of the first pressing portions 92a and the number and positions of the second pressing portions 92b are not limited to those of the above embodiment. For example, the attachment 26 may include one, three or more first pressing portions 92a and one, three or more second pressing portions 92b.

Further, for example, the first and second pressing portions 92a, 92b may press parts interesting the virtual straight line L1 passing through the centers of the plurality of wires 22 on the contact surfaces 85 of the shell rings 25 adjacent to the attachment 26 in the first direction D1 when viewed from the second direction D2. In this case, the attachment 26 may include only the first and second pressing portions 92a, 92b. Further, in this case, the first and second pressing portions 92a, 92b may be one first pressing portion 92a and one second pressing portions 92b, out of the plurality of first pressing portions 92a and the plurality of second pressing portions 92b. By doing so, forces for pressing the wire 22 in the direction parallel to the first direction D1 can be stably transmitted to the wire 22 via the shell ring 25 from the first and second pressing portions 92a, 92b. Therefore, the vibration of the wire 22 in the first direction D1 can be more suppressed.
The shape of the covering portion 91 is not limited to that of the above embodiment. The covering portion 91 only has to be shaped to cover the gap between the shell rings 25 adjacent in the first direction D1.
The configuration and shape of the connector housing 23 are not limited to the configuration and shape in the above embodiment. For example, the inner housing 51 may include one accommodation recess for accommodating the terminals 21a, 21b and 21c. For example, the connector housing 23 may not include either one of the outer housing 41 and the inner housing 51 if the connector housing 23 can hold the terminals 21.
The number of the terminals 21 provided in the connector 20 may be any plural number without being limited to three. Further, the number of the wires 22 provided in the connector 20 may be changed as appropriate according to the number of the terminals 21.
The direction opposite to the first direction D1 in the above embodiment may be the first direction D1. The direction opposite to the third direction D3 in the above embodiment may be the third direction D3.

### LIST OF REFERENCE NUMERALS

20 connector, 21, 21a, 21b, 21c terminal, 22, 22a, 22b, 22c wire, 23 connector housing, 24 shield shell, 25, 25a, 25b, 25c shell ring, 26, 26a, 26b shield attachment (attachment), 27a, 27b, 27c clip terminal, 31 core wire, 32 inner insulation coating, 33 electromagnetic shield member, 33a folded portion, 34 outer insulation coating, 41 outer housing, 42 first end, 43 second end, 44 first connection opening, 45 first opening, 51 inner housing, 52 inner housing body, 53 lid body, 54a, 54b, 54c accommodation recess, 55a, 55b, 55c wire through opening, 56 terminal insertion opening, 61 third end, 62 fourth end, 63 second connection opening, 64 second opening, 65 first contact portion, 66 second contact portion, 67 contact protrusion, 71 fixing portion, 72 extending portion, 73 contacted portion, 75 fixing member, 81 first side surface, 82 second side surface, 83 third side surface, 84 fourth side surface, 85 contact surface, 91 covering portion, 92a first pressing portion (pressing portion), 92b second pressing portion (pressing portion), 93a first extending portion, 93b second extending portion, 94a, 94b leaf spring portion, 95a, 95b contact protrusion, 96 contact portion, 97 contact protrusion, 98a first engaging portion, 98b second engaging portion, 99a first engaging protrusion, 99b second engaging protrusion, 101 back retainer holder, 102a, 102b, 102c through hole, 103a, 103b, 103c first sealing member (sealing member), 104 second sealing member, 105a, 105b mounting portion, 106a first engaging recess, 106b second engaging recess, 111 back retainer, 112a, 112b divided retainer, 201a, 201b, 201c mating terminal, D1 first direction, D2 second direction, D3 third direction, G1, G2 gap, L1 virtual straight line, L2, L3 center line

1. A connector, comprising:
a plurality of terminals arranged in a first direction;
a plurality of wires to be electrically connected to the plurality of terminals;
a connector housing for holding the plurality of terminals inside, the connector housing including a first opening, the plurality of wires being passed through the first opening in a second direction intersecting the first direction;
an electrically conductive shield shell for covering the plurality of terminals;
a plurality of shell rings respectively mounted on the plurality of wires, the shell rings being arranged in the first direction; and
an electrically conductive shield attachment to be arranged between the shell rings adjacent in the first direction,
the shield shell including a second opening, the plurality of wires being passed through the second opening in the second direction,
each of the plurality of wires being a shielded wire including a core wire, an inner insulation coating covering an outer periphery of the core wire and an electrically conductive electromagnetic shield member covering an outer periphery of the inner insulation coating,
each of the plurality of shell rings electrically connecting the electromagnetic shield member of the wire having the shell ring mounted thereon and the shield shell,
an outer peripheral surface of each of the plurality of shell rings having a contact surface to be held in contact with the shield attachment, and
the shield attachment including a covering portion located inside the second opening when viewed from the second direction, the covering portion covering a gap between the shell rings adjacent in the first direction, and a pressing portion to be held in contact with the contact surface adjacent to the shield attachment in the first direction, the pressing portion pressing the contact surface with a force including a component in a direction parallel to the first direction.

2. The connector according to claim 1, wherein the pressing portions press the contact surfaces of the shell rings located on both sides of the shield attachment in the first direction on both sides of a virtual straight line passing through centers of the plurality of wires when viewed from the second direction.

3. The connector according to claim 1, wherein the pressing portion presses a part intersecting a virtual straight line passing through centers of the plurality of wires on the contact surface of the shell ring adjacent to the shield attachment in the first direction when viewed from the second direction.

4. The connector according to claim 1, wherein the shield attachment includes a contact portion to be held in contact with the shield shell.

5. The connector according to claim 1, wherein the pressing portion includes a leaf spring portion and a contact protrusion projecting from a surface of the leaf spring portion and to be pressed against the contact surface by a resilient force of the leaf spring portion.

6. The connector according to claim 1, wherein the contact surface is a flat surface perpendicular to the first direction.

7. The connector according to claim 1, wherein:
each of the plurality of shell rings has a rectangular outer shape when viewed from the second direction,
the outer peripheral surface of each of the plurality of shell rings has two surfaces parallel to the first direction and two surfaces perpendicular to the first direction when viewed from the second direction, and
the contact surface is included in the surface perpendicular to the first direction, out of the outer peripheral surface of each of the plurality of shell rings.

8. The connector according to claim 1, further comprising:
a back retainer holder to be mounted into the first opening, the back retainer holder including a through hole, the plurality of wires being passed through the through hole in the second direction; and
a sealing member for sealing between an outer peripheral surface of each of the plurality of wires and an inner peripheral surface of the through hole,
wherein the shield attachment is arranged between the shell rings adjacent in the first direction while being mounted on the back retainer holder.
